(19) United States
(12) Patent Application Publication
(10) Pub. No.: US 2014/0082819 A1
(43) Pub. Date: Mar. 27, 2014

(54) INFANT BODYSUIT

(71) Applicant: STEVEN BRYAN DUNN, Beverly Hills, CA (US)

(72) Inventor: STEVEN BRYAN DUNN, Beverly Hills, CA (US)

(73) Assignee: Munchkin Inc., North Hills, CA (US)

(21) Appl. No.: 13/625,769

(22) Filed: Sep. 24, 2012

(51) Int. Cl. A41D 11/00; G09F 3/00

(52) U.S. Cl. 2/80; 40/299.01

(57) ABSTRACT

A one-piece bodysuit for an infant. The infant bodysuit having a first panel, and a second panel attached to the first panel. At least one fastener is provided to attach the first panel to the second panel. The first panel is attached at peripheral edges to the second panel to define an opening into which an infant torso is received. The second panel has a fabric weight thickness and thermal property different from a fabric weight thickness and thermal property of the first panel.

### TECHNICAL FIELD

The subject disclosure relates generally to a one-piece infant bodysuit, and more specifically to a thermal insulated infant bodysuit having a first panel thickness different from a second panel thickness.

### BACKGROUND

In newborns and infants, the hypothalamus, and its heat regulation mechanism, is underdeveloped. Consequently, an infant's sweat glands are smaller and blood flow to the outer skin of the child is less efficient. As a result, young infants have a more difficult time acclimating in various environments.

A number of different infant garments are conventionally used by caregivers in an attempt to moderate the temperature of an infant. One common type of clothing worn by infant children (generally from a newborn age to 24 months) is known as an infant bodysuit. As is well known, the infant bodysuit typically covers the torso of the infant with a single article of clothing. Various fasteners are typically used to conveniently allow a caregiver access the infants' crotch area in order to care for and change a soiled infant diaper.

Conventionally, in order to moderate the temperature of an infant, a caregiver would lay a separate blanket or sheet over the infant. However, modernly, various dangers are associated with using a loose blanket or sheet over an infant in their bed, such as suffocation and/or overheating leading to Sudden Infant Death Syndrome (SIDS) and other deadly hazards.

Various professional organizations (such as the National Institute of Child Health and Human Development, Maternal and Child Health Bureau/HRSA, American Academy of Pediatrics, First Candle/SIDS Alliance, Association of SIDS and Infant Mortality Programs, U.S. Department of Health and Human Services, Public Health Service and the National Institutes of Health) recommend that an infant should never be placed to sleep on soft surfaces. They all agree that it is important not to use pillows, blankets, sheet, quilts, sheepskins, and pillow-like crib bumpers in the baby's sleep area, and to keep these types of soft items away from the baby's face. Thus, there is a need to efficiently moderate an infant's temperature in a safe and convenient manner without the addition of a blanket or covering.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates an exemplary infant bodysuit according to the subject disclosure.

FIG. 2 shows a cross section view of the infant bodysuit.

FIG. 3 depicts an infant bodysuit with leg and arm portions according to the subject disclosure.

FIG. 4 illustrates a rear view of the infant bodysuit with leg and arm portions.

FIG. 5 depicts an infant bodysuit having leg, arm and foot covering portions according to the subject disclosure.

FIG. 6 shows a rear view of the infant bodysuit having leg, arm and foot covering portions.

FIG. 7 illustrates a cross section view of the infant bodysuit having leg, arm and foot covering portions.

FIG. 8 shows an infant lying on their back in a crib wearing the infant bodysuit.

FIG. 9 depicts an infant wearing the infant bodysuit and sitting against their back in an infant carrier.

FIG. 10 shows an infant wearing the infant bodysuit and sitting against their back in a stroller.

FIG. 11-13 illustrate a system and method for rating the infant bodysuit.

FIGS. 14-16 depict various exemplary fastener systems for the infant bodysuit.

### DETAILED DESCRIPTION

Particular embodiments of the present invention will now be described in greater detail with reference to the figures.

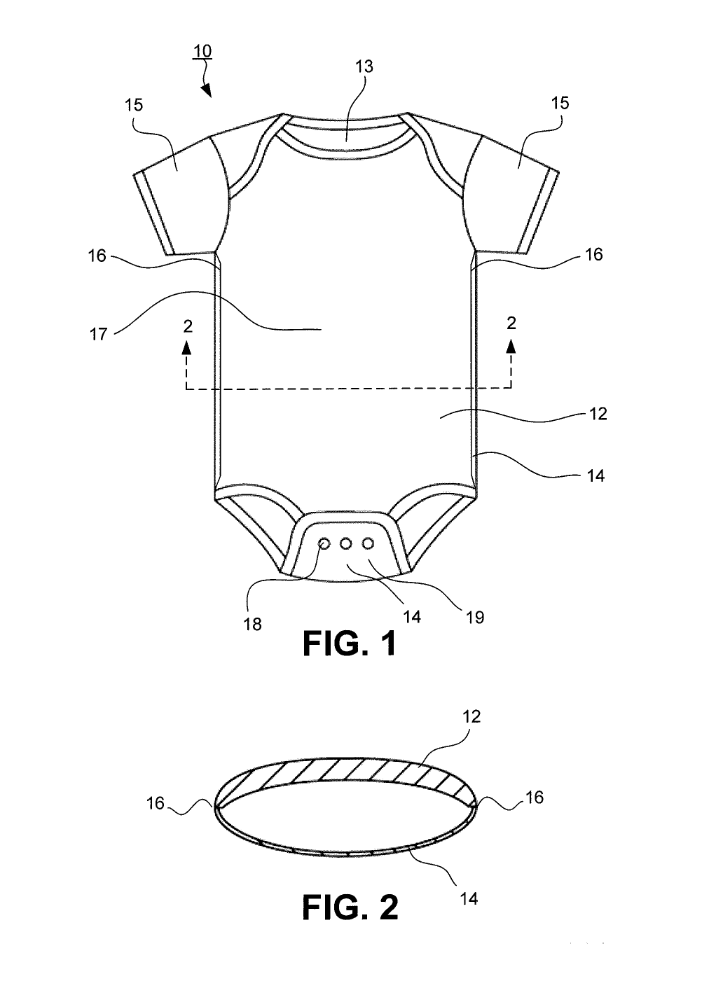

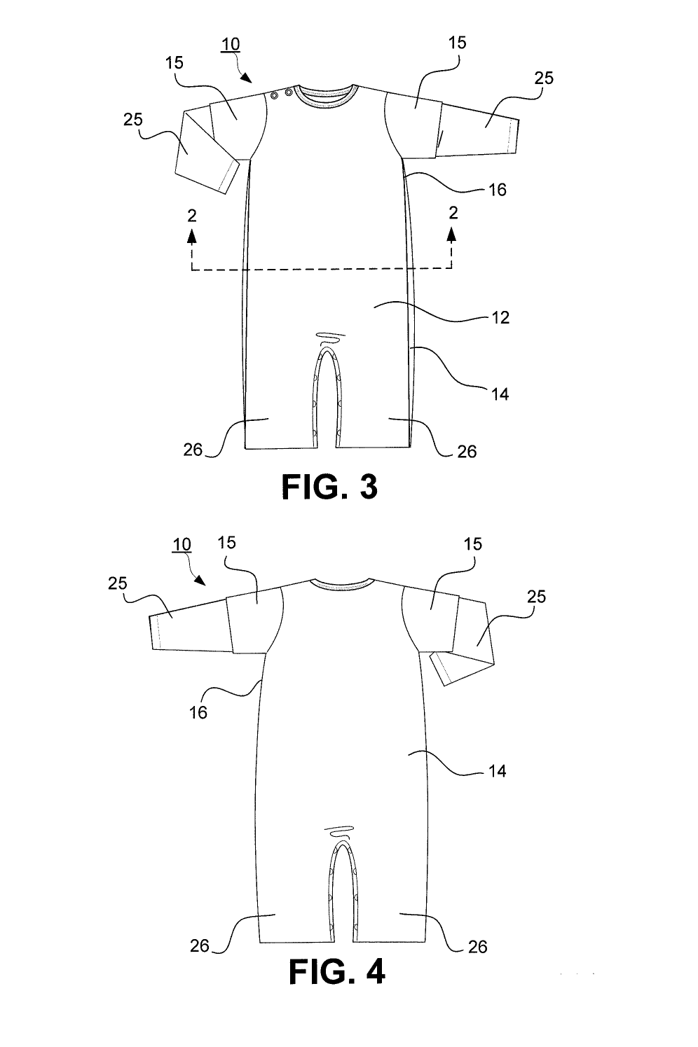

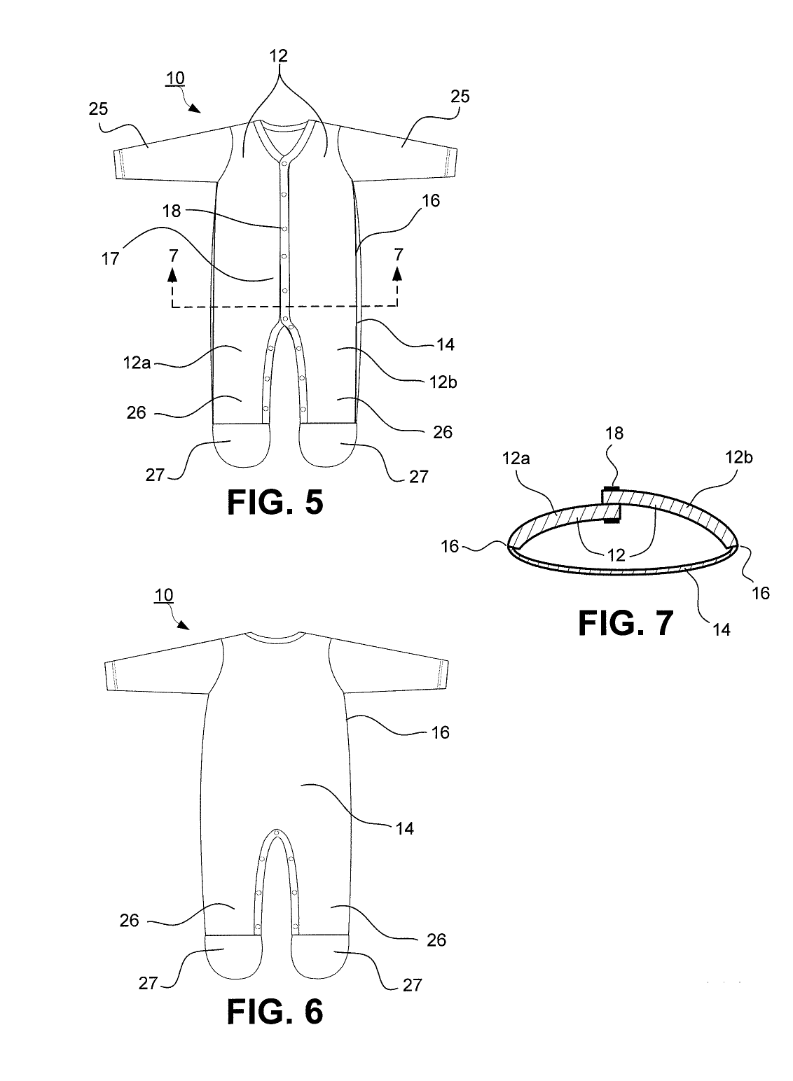

FIGS. 1 and 3-6 illustrate various exemplary infant bodysuits 10. This subject disclosure applies to various infant bodysuits, such as those that do not have sleeves, those with short sleeves 15 or no legs (such as shown in FIG. 1), those with arm 25 and leg 26 portions (as shown in FIGS. 3-6), those with foot coverings 27 (as shown in FIGS. 5-6), or any combination thereof and/or other suitable infant bodysuits.

Referring back to FIG. 1 and FIG. 2, which is a cross section view of FIG. 1. As shown, the infant bodysuit 10 is comprised of a multi-panel construction of varying thickness. The multi-panel construction is adapted to provide enhanced thermal properties similar to the effect of placing a blanket or sheet over an infant. The advantage of the infant bodysuit 10 of this disclosure is that the dangers associated with actually placing a hazardous loose blanket or sheet over the infant 20 are eliminated since a loose blanket, sheet or covering is not provided on, or around the infant 20 according to this subject disclosure.

Conventionally, similar infant bodysuits are non-existent. That is, traditionally, a caregiver would have to lay a separate blanket or sheet over the infant in an attempt to keep the infant warm. However, various dangers have been scientifically proven with placing a loose blanket over a young infant or other soft object in a crib with the infant, such as suffocation, SIDS and/or other deadly hazards.

Various factors compound the problem, such as in the instance where a home includes a single thermostat to regulate the temperature of the entire house. For example, at night, the caregiver may desire a cooler setting so that they can rest warmly under covers while they sleep. Unfortunately, an infant also in the house will not be able to stay comfortably warm at night since using a blanket or other soft item over them in the bed would be ultra-hazardous. Other factors exacerbate the problem, such as where the temperature falls during the evening or a window is left open to allow in air. Consequently, it was previously quite difficult to moderate an infant's temperature in a safe and controlled manner.

As shown in FIG. 1, the infant bodysuit 10 includes a front first panel 12 and a rear second panel 14 of varying thickness and thermal properties. The infant bodysuit 10 further includes a neck opening 13, a pair of sleeves 15, a trunk portion 17, and a bottom portion 19. The infant bodysuit 10 is a one-piece construction in which the various panels 12, 14 and other parts of the bodysuit 10 are constructed integral as a single piece garment. It is to be understood that the bodysuit 10 may be made as a number of component parts and as a multiple-piece garment.

A row of fasteners 18 may be disposed along the rear second panel 14 adapted to be attached to a pair of mating fastener portions provided at the bottom portion of the front first panel 12. Likewise, as shown in the infant bodysuit 10 in FIG. 5, various fasteners 18 may be provided along a front portion of the trunk portion 17 of the front first panel 12 and along the inner leg portions of the infant bodysuit 10 and/or any other suitable location on the infant bodysuit 10.

Referring to FIGS. 1, 3 and 5, the front first panel 12 is attached to the rear second panel 14 at side seams 16. The first panel 12 covers a front torso portion of the infant bodysuit 10. The side seams 16 define peripheral edges that extend from an upper torso of the infant bodysuit 10 to a lower portion of the torso. In FIGS. 3-6, the side seams 16 extend from an upper torso of the infant bodysuit 10 to a lower portion, adjacent to the feet of the infant bodysuit 10.

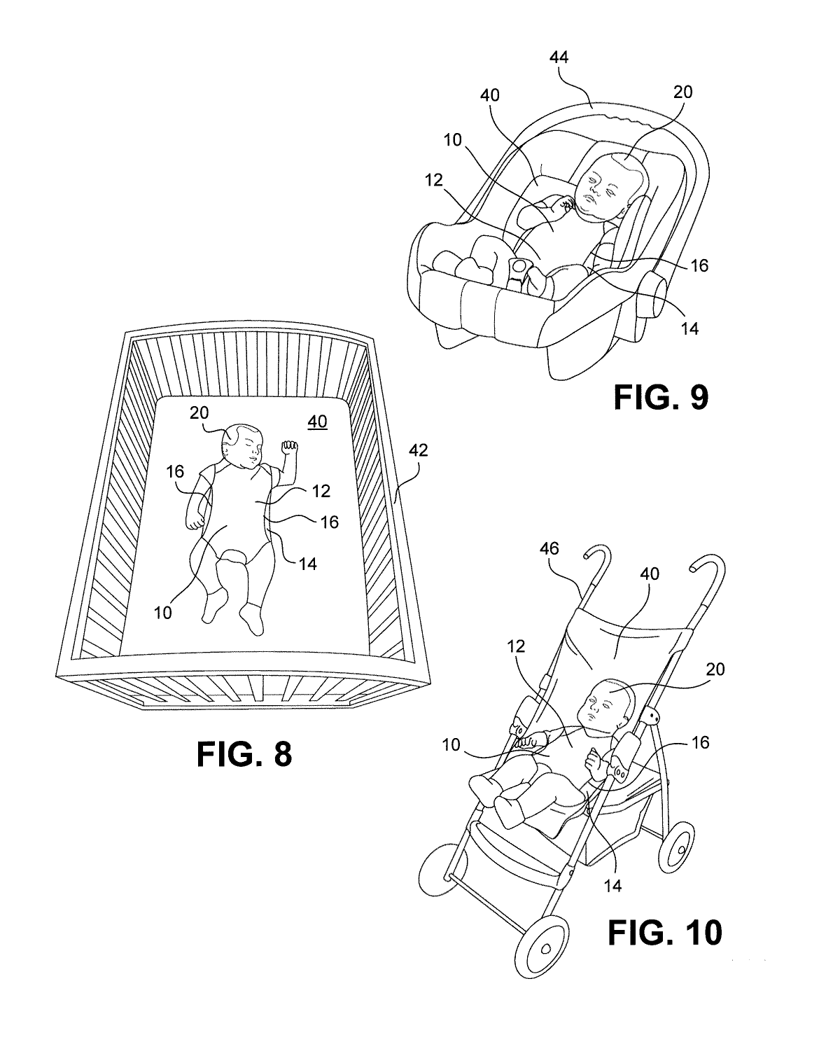

As shown in FIGS. 2 and 7, the front first panel 12 is constructed substantially thicker than the rear second panel 14. The front first panel 12 is thicker than the rear second panel 14 in order to keep the upper outermost portion of an infant 20 warm when the infant 20 is positioned with their back side adjacent to a surface as shown in FIGS. 8-10. The differentiation in the thickness between the first panel 12 and the second panel 14 is associated with various thermal insulating properties as will be discussed later in more detail.

Although the first panel 12 and the second panel 14 are shown as single-piece panels, it is to be understood that the infant body suit 10 may be constructed in a variety of different ways as multi-piece garments. For example, FIGS. 5 and 7 show the front first panel 12 composed of a first front panel portion 12a and a second front panel portion 12b joined together by various fasteners 18.

Likewise, it is also to be understood that the thicknesses in the front first panel 12 and the rear second panel 14 may be reversed in construction according to this disclosure. That is, the second rear panel 14 may be constructed thicker than the front first panel 12.

FIGS. 8-10 illustrate an infant 20 wearing the infant bodysuit 10 and being positioned on their backside against various surfaces 40. In FIG. 8, the infant 20 is shown lying on their back in a crib 42. In FIG. 9, the infant 20 is depicted sitting reclined with their back resting against a surface 40 in an infant carrier 44. And, in FIG. 10, the infant 20 is shown sitting upright with their back resting against a surface 40 in an infant stroller 46.

In each of these positions, heat is naturally transferred from the infant's warm body 20 outward towards the surrounding atmospheric environment that is at a lower temperature. Heat exchange from the infant 20 may take place in various ways, such as by radiation, convection, conduction or a combination of these methods.

In the various environments show in FIGS. 8-10, the infant 20 is shown wearing the bodysuit 10 and is lying with their back against the various surfaces 40. The remainder of the bodysuit 10 on the infant 20 is directly exposed to the atmospheric air. As shown, the majority of the atmospheric air surrounding the upper portion of the infant 20 is in direct contact with the front panel 12 of the infant bodysuit 10.

Heat transfer generated by the body of the infant 20 will flow from the warm infant body (i.e., a high energy and high temperature source) to a surrounding cooler object or the environment (i.e., a low energy and low temperature source). As to the lower surface 40 of the crib 42 shown in FIG. 8, the body heat of the infant's skin lying adjacent to the lower surface 40 is transferred to the surface 40 of the crib 42. The heat energy from the infant's body is radiated into the area adjacent to, and including the lower surface 40 of the crib 42. That is, the heat is transferred from the skin on the back of the infant, through the back of the infant's bodysuit 10 and into the surface 40. Since the gap between the bodysuit 10 and the surface 40 upon which the infant is lying is relatively small, the warmth generated directly from the infant 20 to the area surrounding the back of the infant's bodysuit 10 and the surface 40 collects therein and retains the heat better between the two surfaces. As a result, heat is captured and retained in that region so that the infant 20 remains warm on its back that is in contact with the surface 40 of the crib 42. The same holds true for the surfaces 40 of the infant carrier 44 and the infant stroller 46 shown adjacent to the infant's back in FIGS. 9 and 10.

Conventionally, as to the area adjacent to the front of an infant bodysuit exposed open to the atmospheric air, the heat energy radiated from the infant's body is rapidly radiated away from their body and into the atmospheric surroundings as a result of the large temperature difference between infant and the surrounding atmospheric temperature. Since there is no substantial insulator at the front of a conventional infant garment, more heat is loss via heat convection across the front side of the infant to the colder surrounding atmosphere. Consequently, an infant could not retain as much of its heat and will experience more of a cold chill from the rapid loss of heat into the colder atmospheric surroundings as well as the reciprocal receipt of cold air from the atmosphere.

Referring back to the infant bodysuit 10 according to this subject disclosure as shown in FIG. 2, at least two material panels 12, 14 of differing thickness are attached to each other at the seam 16. Various now known or later discovered methods of attachment between the first panel 12 and the second panel 14 may be used to connect the various fabrics in the infant bodysuit to each other, including but not limited to, sewing, bonding, gluing, and/or other suitable method for attaching the fabrics of the same or different thickness to each other.

The first panel 12 is substantially larger in material thickness then the second panel 14 of the infant bodysuit 10 thereby mimicking the insulation of a blanket, sheet or other soft insulating material over the infant. The differentiation in the weight of the material fabric provides the convenience of providing an all-inclusive infant bodysuit 10 capable of replicating the insulation of a blanket or sheet lying over the infant without

Therefore, as to the area adjacent to the front panel 12 of the infant's bodysuit 10 that is exposed open to the atmospheric air, the heat energy loss radiated from the infant's body 20 is dramatically reduced and substantially prevented from being lost from the infant's body across the infant bodysuit 10 and into the atmospheric surroundings. The thicker first panel 12 acts as an insulator to prevent the loss of heat from the infant's body. The first panel 12 thickness and the second panel 14 thicknesses can be varied depending on the temperature and atmospheric conditions that the infant is to be placed into according to this disclosure.

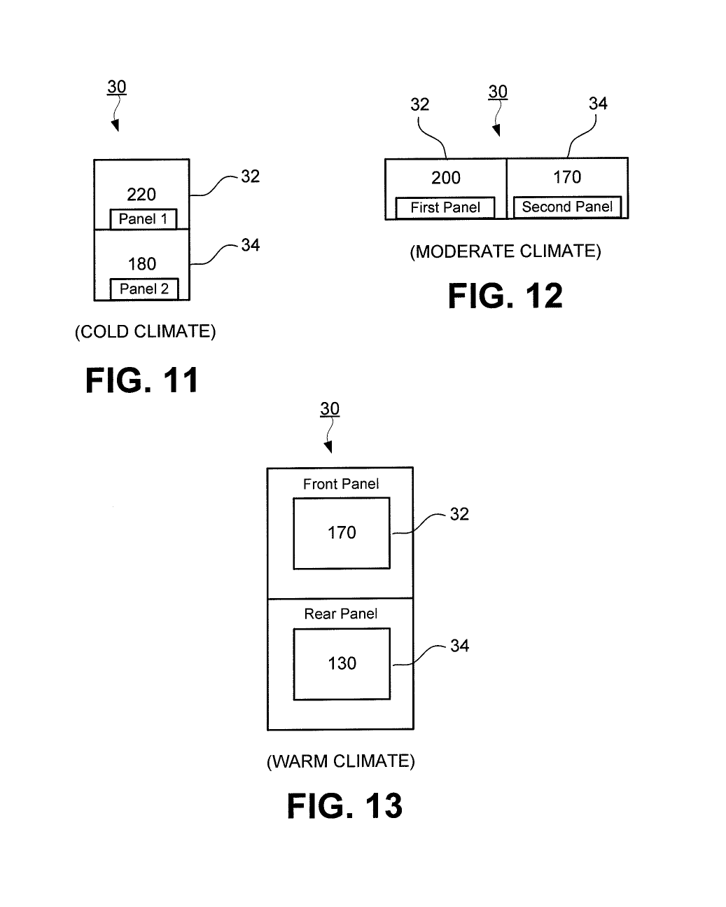

FIGS. 11-13 illustrate a rating system and method for identifying the different fabric/material weights of the multiple components of the infant bodysuit 10. The rating system may be presented as a label 30 including indicia that is based on the weight of the material fabric in grams/meter squared, or other suitable dimension. The differentiation in the weight of the material fabric provides the convenience of providing an all-inclusive infant bodysuit 10 capable of replicating the insulation of a blanket or sheet lying over the infant without the danger of actually laying a loose blanket or sheet on top of the infant thereby alleviating the danger of suffocation as well as other hazards.

The rating system can be associated with a broad range of various temperatures adapted for use and easily identifiable by a caregiver year-round. For example, as shown in FIG. 11, the label 30 may include a first indicia associated with a first rating for a cold weather climate such as an outdoor temperature of 40 degrees or the like. In that case, the label 30 may include “220” as a first indicia 32 used to identify the jersey weight thickness of the first panel 12. Likewise, a second indicia 34 may include “180” to identify the jersey weight thickness of the second panel 14. The unique rating system for the combined material weight for the first and second panels 12, 14 will provide a suitable thickness for the infant bodysuit when in a colder climate, such as outside in a stroller on a cold day. The infant 20 will remain comfortably warm having the heavier rated weight 32 for the material fabric of the first panel 12 to block the colder air and better insulate the infant from the colder atmospheric air.

In a second example shown in FIG. 12, the label 30 may include a first indicia associated with a first rating for a moderate weather climate such as an outdoor temperature of 70 degrees or the like. In that case, the label 30 may include “200” as a first indicia 32 used to identify the jersey weight thickness of the first panel 12. Likewise, the label may include “170” as a second indicia 34 used to identify the jersey weight thickness of the second panel 14. The combined weight of the first and second panels 12, 14 will provide a suitable thickness for the infant bodysuit for the moderate climate. The infant 20 will remain comfortable in the moderate climate having the slightly heavier rated weight 32 for the material fabric of the first panel 12 to better insulate the infant from the moderate atmospheric air. As shown in FIG. 12, the indicia may be positioned in a variety of different shapes and positions.

In a third example shown in FIG. 13, the label 30 may include a first indicia associated with a first rating 32 for a much warmer weather climate such as an outdoor temperature of 85 degrees or the like. In that case, the label 30 may include a first indicia 32 at “170” used to identify the jersey weight thickness of the first panel 12. Likewise, the second indicia 34 may be “130” used to identify the jersey weight thickness of the second panel 14. The combined weight of the first and second panels 12, 14 will provide a suitable thickness for the infant bodysuit for the warmer climate. The infant 20 will be able to remain reasonably cool and protected with a lighter weight fabric at the front panel 12 in the much warmer climate.

As demonstrated, the differing weights and/or reference numbers in the label 30 may be associated with the weather or temperature for a particular day or the environment in which the infant will be located. Likewise, the various ranges may vary by approximately 30 to 50 grams/meter squared and/or any other preferred rating. Although described as a jersey knit fabric in this example it is to be understood that any suitable fabric may be used according to the subject disclosure.

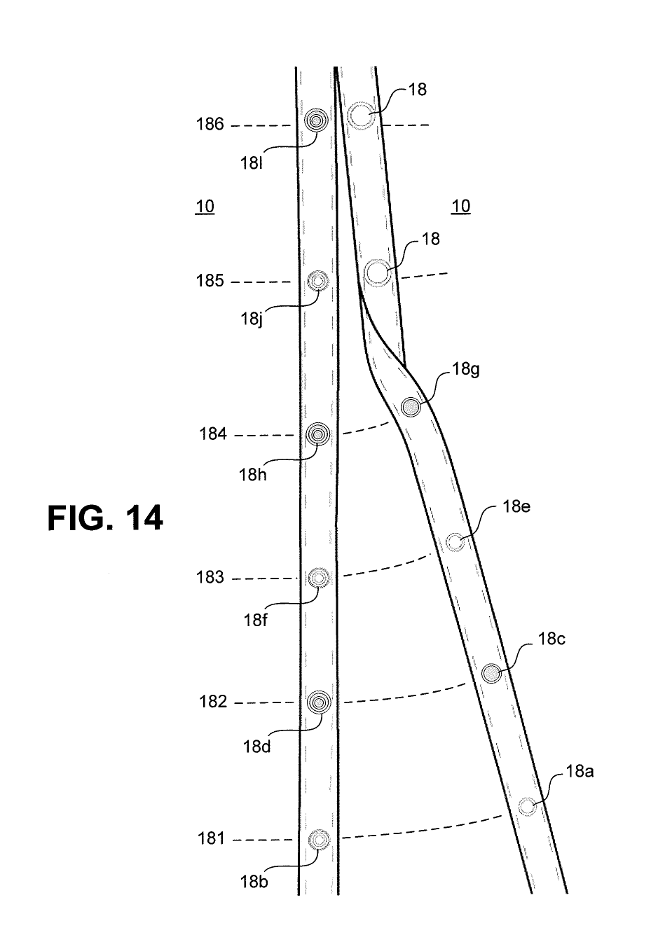

FIGS. 14-16 illustrate a further aspect of the subject disclose in which various fasteners 18 used on the infant bodysuit 10 are constructed in a variety of different sizes, shapes, materials and colors in order to assist the caregiver when securing the infant bodysuit 10 to the infant 20. For example, in FIG. 14, the various fasteners 18 depict various first snap sockets 18a, 18c, 18e, 18g, 18i (not shown), 18k (not shown), aligned with, and positioned to align with, mating receiving snap studs 18b, 18d, 18f, 18h, 18j, 18l. It is to be understood that the various fasteners 18 may be uniquely arranged and positioned anywhere on the infant bodysuit 10.

As shown, the various snap sockets 18a, 18c, 18e, 18g are paired with associated mating snap studs 18b, 18d, 18f, 18h in an alternating color scheme. For example, at the lower end of the fastener assembly, a first fastener arrangement 181 includes a snap socket 18a paired with a snap stud 18b of a similar first color. A second fastener assembly 182 located above the first fastener assembly 181 includes a snap socket 18c paired with a snap stud 18d of a second color. Proceeding upward, a third fastener assembly 183 located above the second fastener assembly 182 includes a snap socket 18e paired with an associated snap stud 18f of the first color. Proceeding upward again, a fourth fastener assembly 184 located above the third fastener assembly 183 includes a snap socket 18g paired with an associated snap stud 18h of the second color. The fifth and sixth fastener assemblies 185, 186 would follow the same alternating scheme.

As shown, the first and second fastener color scheme is provided in the infant bodysuit 10 to alternate in adjacent positions. The advantage of constructing this alternating fastener color scheme is to provide the caregiver with a visual indicator as to the proper alignment of associated pairs of snap studs and snap sockets. In this manner, the caregiver can conveniently and easily align the proper pairs of snap studs and snap sockets on the infant bodysuit 10. Although shown as an alternating color scheme, the associated pairs of snap studs and snap sockets may be distinguished by various parameters, such as size, shape material as well as color. Further, more than two color schemes may be utilized amongst the various fasteners 18 positioned adjacent to each other.

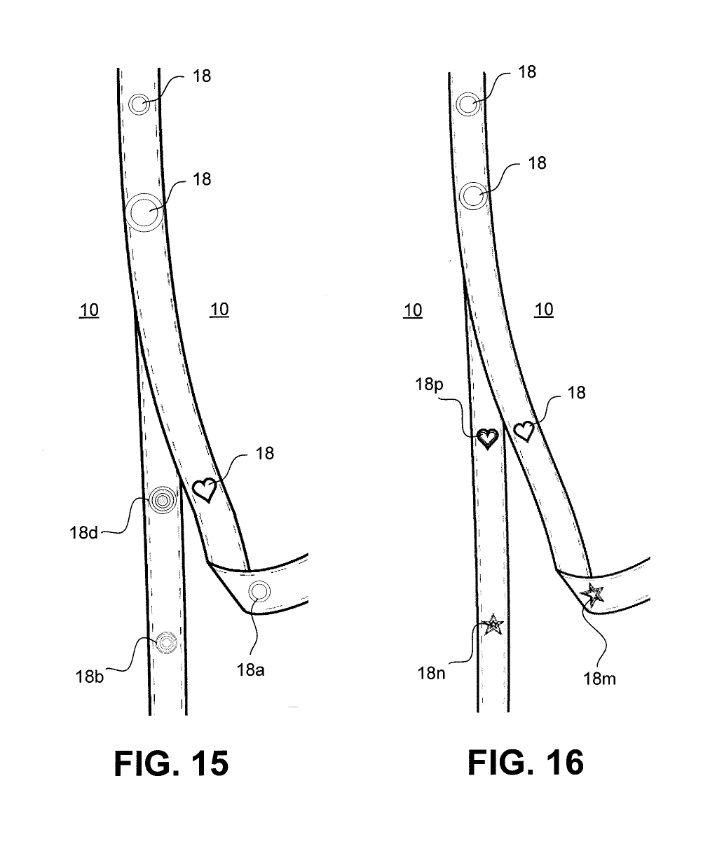

As illustrated at the top of FIG. 14, the outside of the fasteners 18 of the fastener assemblies 185 and 186 appear substantially similar when the fasteners 18 are closed. In an alternative, FIG. 15 shows an example of the outside of the fasteners 18 having a different appearance. In FIG. 15, the first uppermost fastener 18 is smaller in construction then the outside of the next lower fastener 18, which is much larger.

As shown in FIGS. 15 and 16, it is within the scope of this disclosure to vary the construction of the fasteners into an assortment of different sizes, shapes, materials and colors, such as a small circle, a large circle, a heart, a star, and/or any other shape, size or color. As mentioned previously, the snap studs and mating snap sockets can be color coordinated, such as by matching the innermost or outermost elements of the fasteners in brass, silver and/or any other preferred color as shown in FIGS. 14-15 and in accordance with this disclosure.

Likewise, the inner snap stud and snap socket can be constructed in any configuration. For example, FIG. 16 depicts the inner male snap socket 18m and female snap stud 18n taking the shape of a star. Shown above the heart is the inner male snap socket and female snap stud 18p fastener assembly taking the shape of a heart. Any suitable size or shape can be constructed according to this disclosure.

The advantage to providing different sizes, shapes and/or colors to the fasteners is to conveniently and easily allow the caregiver to secure the infant's bodysuit 10 onto the infant 20. Alignment of the numerous fasteners 18 can be performed conveniently without misaligning the fasteners 18 since both visual and tactile distinctions can be easily and readily apparent to the caregiver who aligns the various fasteners 18 on the infant bodysuit 10.

Traditionally, aligning the various fasteners has been quite challenging, especially when an infant is kicking and thrusting their arms and legs around as the caregiver attempts to snap fasten an infant suit onto the infant. By providing the visual and tactile distinctions of the fasteners 18 according to this subject disclosure, the caregiver can more easily align the appropriate snap studs and mating snap sockets positions.

Although snap fasteners are discussed herein, it is to be understood that various fasteners may be selected, such as but not limited to, snaps studs with associated snap sockets, pins, hook and loop fastener, and/or any other suitable fastener capable of fastening the infant bodysuit in accordance with the subject disclosure.

Each of the features described herein increases the comfort of the infant by providing warmth, visual indicia identifying the material weight and thickness of the infant bodysuit 10 and easy and convenience to the caregiver placing the infant bodysuit 10 onto the infant 20. These various features improve the appearance of the infant bodysuit 10. It is believed that each of the features of the bodysuit 10 also increase the ease of use of the bodysuit 10 to the caregiver, by providing easily identifiable fasteners that are tactile and visually convenient to align and fasten together.

While various features of the present design have been discussed separately, it should be understood that any of these features may be combined in a body suit 10 with or without any other of the features or combination of the features. The infant bodysuit design described herein is applicable to any different type of infant bodysuit. Thus, it may be applicable to bodysuits having different types of neck openings, sleeves, and composed of any material suitable for a bodysuit, and could be equally applicable to other possible variations of bodysuits.

Various material and fabrics may be used in accordance with the subject disclosure. For example, various natural and/or man-made fabrics may be employed, such as knits and woven fabrics selected from at least one of a light weight, medium weight, and/or heavy weight fabric and/or other suitable material fabric. The infant bodysuit 10 can also be made from a light, stretchable material, such as elasticized cotton, muslin, fleece, blended materials and/or other suitable material. Other materials may include the use of organic and/or unbleached materials which are suitable for infant care.

The first panel 12 may be constructed to be a thicker weave construction than the second panel 14 of the infant bodysuit 10. The finished material is preferably an ultra soft fabric so that when placed against a baby's skin, the material is extremely soft and soothing to the infant. In order to obtain a soft fabric construction, various softening processes may be applied to the fabric, such as for example, using silicon to soften the fabric, washing the material, mechanically brushing the fabric to soften the material fabric and/or any other suitable type of softening process in accordance with the subject disclosure.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. A one-piece infant bodysuit comprising:
a first panel having a first material weight thickness; and
a second panel having a second material weight thickness different from the first panel,
wherein the first panel is attached at peripheral edges to the second panel to define an opening into which an infant torso is received.

2. The one-piece infant bodysuit recited in claim 1, wherein the first panel covers a front torso portion of the infant body suit, and the second panel covers a rear torso portion of the infant body suit, and wherein the peripheral edges define seams extending from an upper torso to a lower torso along the infant bodysuit.

3. The one-piece infant bodysuit recited in claim 1, wherein the first panel covers a front torso portion of the infant body suit, and wherein the peripheral edges define seams extending from an upper torso to a lower portion of the infant bodysuit.

4. The one-piece infant bodysuit recited in claim 1, further comprising a label comprising a first indicia associated with the first panel, and a second indicia associated with the second panel.

5. The one-piece infant bodysuit recited in claim 4, wherein the first indicia defines a first thermal property associated with the first material weight thickness of the first panel, and the second indicia defines a second thermal property associated with the second material weight thickness of the second panel.

6. The one-piece infant bodysuit recited in claim 1, wherein a fastener assembly is provided including at least two fasteners of different colors are positioned adjacent to each other in the bodysuit and are adapted to provide a visual alignment indicator for each of the fasteners.

7. The one-piece infant bodysuit recited in claim 6, where in each of the two fasteners includes a two-piece inner mating construction, and each piece of the two-piece inner mating construction of a single fastener is composed of the same color in order to provide the visual alignment indication, and
wherein an outer visible portion of the two fasteners adjacent to each other are substantially similar.

8. The one-piece infant bodysuit recited in claim 7, wherein more than two fasteners are positioned adjacent to each other and the color scheme alternates between the two color schemes to provide the visual alignment indication for each of the fasteners.

9. The one-piece infant bodysuit recited in claim 1, wherein a fastener assembly is provided including at least two fasteners of different types are positioned adjacent to each other in the bodysuit and are adapted to provide a visual alignment indicator.

10. An infant bodysuit comprising:
a first panel having a first material weight associated with a first thermal property; and
a second panel having a second material weight associated with a second thermal property different from the first panel, and
wherein the first panel is attached at peripheral edges to the first panel to define an opening into which an infant torso is received.

11. The infant bodysuit recited in claim 10, wherein the first panel covers a front torso portion of the infant body suit, and the second panel covers a rear torso portion of the infant body suit, and wherein the peripheral edges define seams extending from an upper torso to a lower portion of the infant bodysuit.

12. The infant bodysuit recited in claim 10, further comprising a label having a first indicia associated with the first material weight of the first panel and a second indicia associated with the second material weight of the second panel.

13. The infant bodysuit recited in claim 10, wherein a fastener assembly comprises at least two fasteners of different colors positioned adjacent to each other and adapted to provide a visual alignment indicator.

14. The infant bodysuit recited in claim 13, where in each of the two fasteners includes a two-piece inner mating construction, and each piece of the two-piece inner mating construction of a single fastener is composed of a same color in order to provide the visual alignment indication.

15. The infant bodysuit recited in claim 14, wherein more than two fasteners are positioned adjacent to each other and the color scheme alternates between the two color schemes to provide the visual alignment indication of each of the fasteners.

16. The infant bodysuit recited in claim 10, wherein the fastener assembly comprises at least two fasteners of different types being positioned adjacent to each other in the bodysuit and adapted to provide a visual alignment indicator of each of the fasteners.

17. An infant bodysuit comprising:
a first panel;
a second panel attached at seams to the first panel defining an opening into which an infant torso is received; and
a label having a first indicia associated with a first material weight of the first panel, and a second indicia associated with a second material weight of the second panel different from the first panel.

18. The infant bodysuit recited in claim 17, wherein the first panel covers a front torso portion of the infant body suit, and the second panel covers a rear torso portion of the infant body suit and is thicker than the first panel, and wherein the seams extend from an upper torso to a lower portion of the infant bodysuit.

19. The infant bodysuit recited in claim 17, wherein the infant bodysuit further comprises at least two fasteners of different types being positioned adjacent to each other in the bodysuit and adapted to provide a visual alignment indicator for each of the fasteners.

20. The infant bodysuit recited in claim 17, wherein the infant bodysuit further comprises:
a fastener assembly having at least two fasteners of different colors positioned adjacent to each other, wherein each of the fasteners includes a two-piece inner mating construction, and each piece of the two-piece inner mating construction of a single fastener is composed of a similar color in order to provide the visual alignment indication.
